(19) United States
(12) Patent Application Publication
(10) Pub. No.: US 2016/0173789 A1
(43) Pub. Date: Jun. 16, 2016

(54) IMAGE GENERATION METHOD AND APPARATUS, AND MOBILE TERMINAL

(71) Applicant: Sony Corporation, Tokyo (JP)

(72) Inventors: Gang XU, Beijing (CN); Yuejie TAN, Beijing (CN); Honghao WANG, Beijing (CN); Chengliang DING, Beijing (CN); Zhong LI, Beijing (CN); Junsheng LIU, Beijing (CN)

(21) Appl. No.: 14/778,372

(22) PCT Filed: Feb. 16, 2015
(86) PCT No.: PCT/IB2015/051117

§ 371 Date: Sep. 18, 2015

(30) Foreign Application Priority Data
Jul. 2, 2014 (CN) 201410312286.7

(51) Int. Cl. H04N 5/272; H04N 5/262; G06K 9/34; H04N 5/225

(52) U.S. Cl. CPC H04N 5/272; H04N 5/2257; H04N 5/2628; G06K 9/342

(57) ABSTRACT

The embodiments of the present disclosure provide an image generation method and apparatus and a mobile terminal. The image generation method includes: acquiring an initial image by using an image acquisition member; generating at least two layers including a processing layer having an object to be processed and a background layer for background display, based on the initial image; processing the object to be processed to obtain a processed processing layer, and/or processing the background layer to obtain a processed background layer; and merging the at least two layers including the processed processing layer and/or the processed background layer to obtain an image. Through the embodiments of the present disclosure, the personalized image shooting can be carried out in real time to obtain better user experiences.

### CROSS-REFERENCE TO RELATED PATENT APPLICATION AND PRIORITY CLAIM

Priority is claimed from Chinese patent application No. 201410312286.7, filed Jul. 2, 2014, the entire disclosure of which hereby is incorporated by reference.

### TECHNICAL FIELD

The present disclosure relates to the technology of mobile communications, and particularly, to an image generation method and apparatus, and a mobile terminal.

### BACKGROUND

With the development of technologies, more and more mobile terminals have a shooting function, such as a communication mobile terminal (cellular phone), a photo camera, a tablet PC, etc. at present. Through shooting elements disposed in those mobile terminals, a user can shoot the images and videos whenever and wherever possible.

To be noted, the above introduction to the technical background is just made for the convenience of clearly and completely describing the technical solutions of the present disclosure, and to facilitate the understanding by a person skilled in the art. It shall not be deemed that the above technical solutions are known to a person skilled in the art just because they have been illustrated in the Background section of the present disclosure.

### SUMMARY

However, the inventor finds that at present, during the image shooting by the mobile terminal, only an actually existed scene can be shot while a better creative shooting cannot be carried out. For example, when an object stands under a big tree, the mobile terminal can just shoot the actual scene, without obtaining an image in which the object stands on the top of the big tree. Thus in the current image shooting by the mobile terminal, a personalized shooting cannot be performed, and better user experiences cannot be obtained.

The embodiments of the present disclosure provide an image generation method and apparatus and a mobile terminal. By generating at least two layers, performing an operation on the object to be processed in a layer, and merging the layers to obtain a final image, the personalized image shooting can be carried out in real time to obtain better user experiences.

According to a first aspect of the embodiment of the present disclosure, an image generation method is provided, including:

acquiring an initial image by using an image acquisition member;

generating at least two layers including a processing layer having an object to be processed and a background layer for background display, based on the initial image;

processing the object to be processed to obtain a processed processing layer, and/or processing the background layer to obtain a processed background layer; and

merging the at least two layers including the processed processing layer and/or the processed background layer to obtain an image.

According to a second aspect of the embodiment of the present disclosure, wherein generating at least two layers including a processing layer having an object to be processed and a background layer for background display based on the initial image, includes:

acquiring at least two initial images;

taking an image not containing the object to be processed among the at least two initial images as the background layer;

comparing an image containing the object to be processed among the at least two initial images with the background layer, and obtaining the object to be processed according to a result of the comparison.

According to a third aspect of the embodiment of the present disclosure, wherein generating at least two layers including a processing layer having an object to be processed and a background layer for background display based on the initial image, includes:

generating the background layer based on the initial image; and

performing image recognition of the initial image based on pre-stored image information, so as to acquire the object to be processed corresponding to the pre-stored image information.

According to a fourth aspect of the embodiment of the present disclosure, wherein processing the object to be processed to obtain a processed processing layer includes:

setting the background layer in a visible and disabled state, and setting the processing layer in a visible and enabled state;

processing the object to be processed by using an information input member, so that the object to be processed is overlap-displayed on the background layer after the processing.

According to a fifth aspect of the embodiment of the present disclosure, wherein processing the object to be processed to obtain a processed processing layer includes:

processing the object to be processed based on pre-stored history information, so that the object to be processed is overlap-displayed on the background layer after the processing.

According to a sixth aspect of the embodiment of the present disclosure, wherein processing the object to be processed includes one or combinations of the operations of changing a position of the object to be processed, changing a size of the object to be processed, changing a state of the object to be processed, and changing a display attribute of the object to be processed.

According to a seventh aspect of the embodiment of the present disclosure, wherein after processing the object to be processed to obtain a processed processing layer, the image generation method further includes:

reacquiring an initial image, and generating an updated object to be processed;

mapping the updated object to be processed into the processing layer, so as to obtain an updated processing layer.

According to an eighth aspect of the embodiment of the present disclosure, wherein the initial image is reacquired by using the image acquisition member, or by being selected from pre-stored images, or by being received through a network interface.

According to a ninth aspect of the embodiment of the present disclosure, an image generation apparatus is provided, including:

an image acquisition unit, configured to acquire an initial image by using an image acquisition member;

a layer generation unit, configured to generate at least two layers including a processing layer having an object to be processed and a background layer for background display, based on the initial image;

a layer processing unit, configured to process the object to be processed to obtain a processed processing layer, and/or process the background layer to obtain a processed background layer; and

a layer merging unit, configured to merge the at least two layers including the processed processing layer and/or the processed background layer to obtain an image.

According to a tenth aspect of the embodiment of the present disclosure, wherein the image acquisition member acquires at least two initial images;

the layer generation unit is configured to take an image not containing the object to be processed among the at least two initial images as the background layer; and to compare an image containing the object to be processed among the at least two initial images with the background layer, and obtain the object to be processed according to a result of the comparison.

According to an eleventh aspect of the embodiment of the present disclosure, wherein the layer generation unit is configured to generate the background layer based on the initial image; and to perform image recognition of the initial image based on pre-stored image information, so as to acquire the object to be processed corresponding to the pre-stored image information.

According to a twelfth aspect of the embodiment of the present disclosure, wherein the layer processing unit includes:

a state setting unit, configured to set the background layer in a visible and disabled state, and to set the processing layer in a visible and enabled state;

an object processing unit, configured to process the object to be processed by using an information input member, so that the object to be processed is overlap-displayed on the background layer after the processing.

According to a thirteenth aspect of the embodiment of the present disclosure, wherein the layer processing unit is configured to process the object to be processed based on pre-stored history information, so that the object to be processed is overlap-displayed on the background layer after the processing.

According to a fourteenth aspect of the embodiment of the present disclosure, wherein processing the object to be processed includes one or combinations of the operations of changing a position of the object to be processed, changing a size of the object to be processed, changing a state of the object to be processed, and changing a display attribute of the object to be processed.

According to a fifteenth aspect of the embodiment of the present disclosure, wherein the image generation apparatus further includes:

an object update unit, configured to reacquire an initial image and to generate an updated object to be processed; and

an object mapping unit, configured to map the updated object to be processed into the processing layer, so as to obtain an updated processing layer.

According to a sixteenth aspect of the embodiment of the present disclosure, wherein the initial image is reacquired by using the image acquisition member, or by being selected from pre-stored images, or by being received through a network interface.

According to a seventeenth aspect of the embodiment of the present disclosure, a mobile terminal is provided, including the aforementioned image generation apparatus.

Embodiments of the present disclosure have the following beneficial effect: at least two layers including a processing layer and a background layer are generated based on the initial image; the object to be processed is processed to obtain a processed processing layer, and/or the background layer is processed to obtain a processed background layer; and the at least two layers including the processed processing layer and/or the processed background layer are merged to obtain an image. Thus, the personalized image shooting can be carried out in real time to obtain better user experiences.

These and other aspects of the present disclosure will be clear with reference to the subsequent descriptions and drawings, which disclose particular embodiments of the present disclosure to indicate some implementations of principles of the present disclosure. But it shall be appreciated that the scope of the present disclosure is not limited thereto, and the present disclosure includes all the changes, modifications and equivalents falling within the scope of the spirit and the connotations of the accompanied claims.

Features described and/or illustrated with respect to one embodiment can be used in one or more other embodiments in a same or similar way, and/or by being combined with or replacing the features in other embodiments.

To be noted, the term “comprise/include” used herein specifies the presence of feature, element, step or component, not excluding the presence or addition of one or more other features, elements, steps or components or combinations thereof.

Many aspects of the present disclosure will be understood better with reference to the following drawings. The components in the drawings are not surely drafted in proportion, and the emphasis lies in clearly illustrating principles of the present disclosure. For the convenience of illustrating and describing some portions of the present disclosure, corresponding portions in the drawings may be enlarged, e.g., being more enlarged relative to other portions than the situation in the exemplary device practically manufactured according to the present disclosure. The parts and features illustrated in one drawing or embodiment of the present disclosure may be combined with the parts and features illustrated in one or more other drawings or embodiments. In addition, the same reference signs denote corresponding portions throughout the drawings, and they can be used to denote the same or similar portions in more than one embodiment.

### BRIEF DESCRIPTION OF THE DRAWINGS

The accompanying drawings are included to provide further understanding of the present disclosure, and they constitute a part of the Specification. Those drawings illustrate the preferred embodiments of the present disclosure, and explain principles of the present disclosure with the descriptions, wherein the same element is always denoted with the same reference sign.

In the drawings,

FIG. 1 is a flow diagram of an image generation method according to an embodiment of the present disclosure;

FIG. 2 is another flow diagram of an image generation method according to an embodiment of the present disclosure;

FIG. 3 is an example diagram of generating a background layer according to an embodiment of the present disclosure;

FIG. 4 is an example diagram of generating a processing layer according to an embodiment of the present disclosure;

FIG. 5 is an example diagram of overlap-displaying the background layer and the processing layer according to an embodiment of the present disclosure;

FIG. 6 is a schematic diagram of performing an operation on an object to be processed according to an embodiment of the present disclosure;

FIG. 7 is another schematic diagram of performing an operation on an object to be processed according to an embodiment of the present disclosure;

FIG. 8 is a schematic diagram when an operation is completed according to an embodiment of the present disclosure;

FIG. 9 is another flow diagram of an image generation method according to an embodiment of the present disclosure;

FIG. 10 is an example diagram of an updated processing layer according to an embodiment of the present disclosure;

FIG. 11 is a structural diagram of an image generation apparatus according to an embodiment of the present disclosure;

FIG. 12 is another structural diagram of an image generation apparatus according to an embodiment of the present disclosure;

FIG. 13 is a structural diagram of a mobile terminal according to an embodiment of the present disclosure; and

FIG. 14 is a block diagram of a system construction of a mobile terminal according to an embodiment of the present disclosure.

### DESCRIPTION OF THE EMBODIMENTS

The interchangeable terms “electronic device” and “electronic apparatus” include a portable radio communication device. The term “portable radio communication device”, which is hereinafter referred to as “mobile radio terminal”, “portable electronic apparatus”, or “portable communication apparatus”, includes all devices such as mobile phone, pager, communication apparatus, electronic organizer, personal digital assistant (PDA), smart phone, portable communication apparatus, etc.

In the present application, the embodiments of the present disclosure are mainly described with respect to a portable electronic apparatus in the form of a mobile phone (also referred to as “cellular phone”). However, it shall be appreciated that the present disclosure is not limited to the case of the mobile phone and it may relate to any type of appropriate electronic device, such as media player, gaming device, PDA and computer, digital video camera, tablet PC, wearable electronic device, etc.

### Embodiment 1

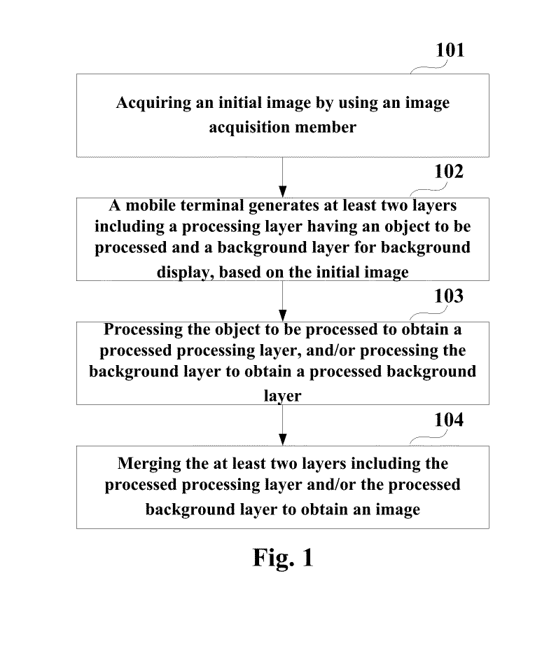

This embodiment of the present disclosure provides an image generation method. FIG. 1 is a flow diagram of an image generation method according to an embodiment of the present disclosure. As illustrated in FIG. 1, the image generation method includes:

Step 101: acquiring an initial image by using an image acquisition member;

Step 102: a mobile terminal generates at least two layers including a processing layer having an object to be processed and a background layer for background display, based on the initial image;

Step 103: processing the object to be processed to obtain a processed processing layer, and/or processing the background layer to obtain a processed background layer; and

Step 104: merging the at least two layers including the processed processing layer and/or the processed background layer to obtain an image.

In this embodiment, the image generation method may be applied to the mobile terminal. The mobile terminal for example may be a digital photo camera, a smart phone, a tablet PC, a wearable device, etc. The image acquisition member for example may be a camera. But the present disclosure is not limited thereto. The mobile terminal may control the camera.

The camera may be disposed in the mobile terminal (e.g., it may be a front-facing camera of the smart phone), or removably integrated with the mobile terminal through an interface. In addition, the camera may also be connected to the mobile terminal wiredly or wirelessly, for example being controlled by the mobile terminal through WiFi. The present disclosure is not limited thereto, and other manners may be adopted to connect the mobile terminal with the camera. Next, the descriptions are given through an example where the camera is disposed in the mobile terminal.

In this embodiment, the object to be processed may be a region hoped to be processed in the image, for example a portrait portion in the image corresponding to a user shot as the object, or a landscape portion in the image corresponding to a body shot as the object. But the present disclosure is not limited thereto, and the object to be processed, for example, may be another portion in the image.

In addition, at least two layers including a processing layer and a background layer may be generated according to at least two initial images. But the present disclosure is not limited thereto, and at least two layers including a processing layer and a background layer may also be generated according to just one initial image. For example, a portrait portion in the image may be recognized as the processing layer, and the other portion except the portrait portion may be taken as the background layer.

In this embodiment, the processing layer may be processed, as described in a later embodiment below. In addition, the background layer may be processed, for example by changing brightness, contrast, etc. of the background layer. Furthermore, the processing of the background layer may be similar to that of the processing layer.

Thus, the object and the background desired by the user may be combined together by processing the processing layer and/or the background layer and merging the processed processing layer and/or the processed background layer, thereby performing a personalized image shooting in real time to obtain better user experiences.

In this embodiment, generating at least two layers including a processing layer having an object to be processed and a background layer for background display based on the initial image may include: acquiring at least two initial images; taking an image not containing the object to be processed among the at least two initial images as the background layer; and comparing an image containing the object to be processed among the at least two initial images with the background layer, and obtaining the object to be processed according to a result of the comparison.

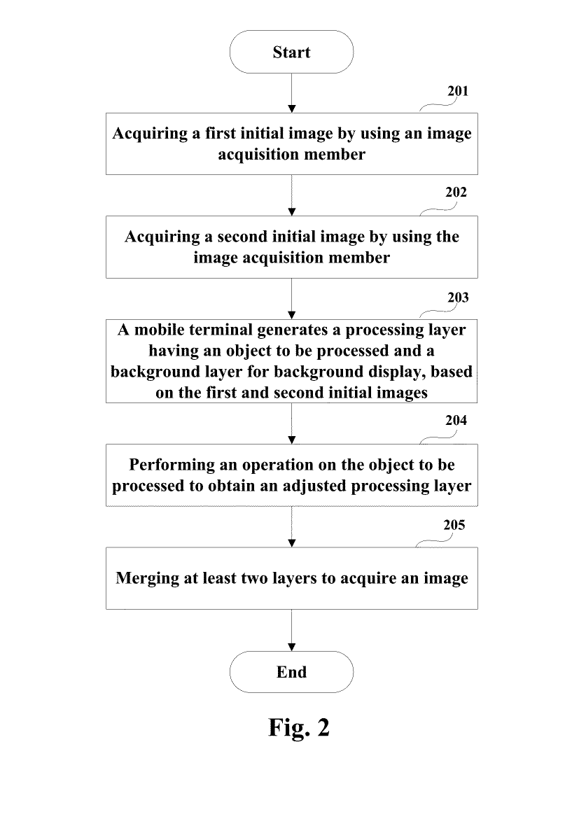

FIG. 2 is another flow diagram of an image generation method according to an embodiment of the present disclosure, and the present disclosure is described through an example using two layers. As illustrated in FIG. 2, the image generation method includes:

Step 201: acquiring a first initial image by using an image acquisition member;

wherein, the first initial image does not contain an object to be processed.

Step 202: acquiring a second initial image by using the image acquisition member;

wherein, the second initial image contains an object to be processed.

For example, firstly a person taken as the object is kept outside a shooting range, e.g., also referred to as field of view, of the camera, and a first initial image is obtained by shooting the landscape with the camera; next, the person taken as the object is allowed to enter the shooting range of the camera, and a second initial image is obtained by shooting the same scene at the same angle.

Step 203: a mobile terminal generates a processing layer having an object to be processed and a background layer for background display, based on the first and second initial images.

In this embodiment, an image not containing the object to be processed (i.e., the first initial image) among the at least two initial images may be taken as the background layer; and an image containing the object to be processed (i.e., the second initial image) among the at least two initial images may be compared with the background layer, so as to obtain the object to be processed according to a result of the comparison.

For example, with respect to the same background, firstly a first image having no object is acquired as the background layer, and then a second image having an object is acquired. The first image and the second image are compared with each other, and the image of the object is acquired according to a result of the comparison. For example related technology may be adopted to calculate differences between RGB values or YCbCr values of pixel points in the first and second images, thereby obtaining the object to be processed. Please refer to the relevant art for the detailed process. Steps 204 and 205 are described further below together with description of subsequent drawing figures.

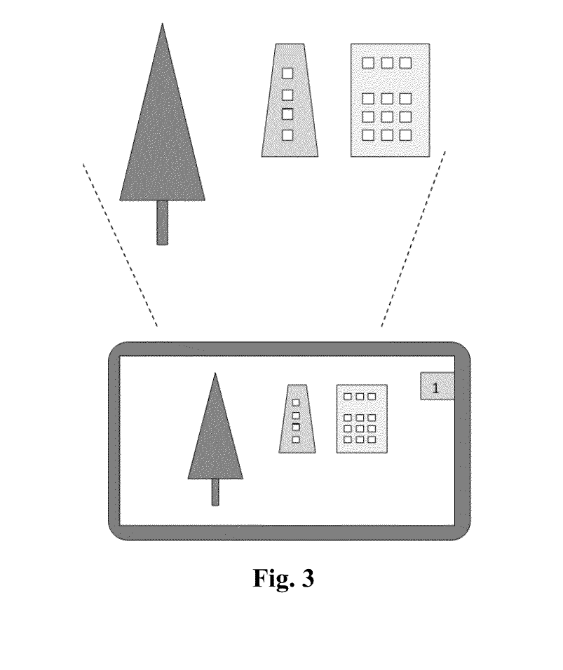

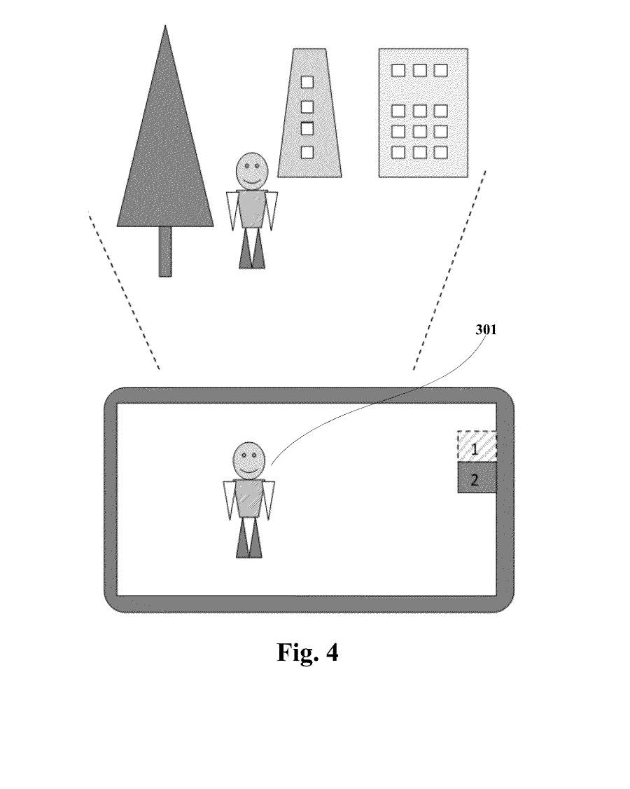

FIG. 3 is an example diagram of generating a background layer according to an embodiment of the present disclosure, and FIG. 4 is an example diagram of generating a processing layer according to an embodiment of the present disclosure. As illustrated in FIGS. 3 and 4, an image not containing an object 301 to be processed is acquired as background layer 1 through a camera. Next, an image containing the object 301 to be processed is acquired through the camera, and processing layer 2 is generated by removing the background portion in the image. The layers 1 and 2 being designated are shown by respective highlighted numbers at the right-hand side of the respective drawing figures.

Step 204 (illustrated in FIG. 2): performing an operation on the object to be processed to obtain an adjusted processing layer.

In this embodiment, the background layer may be set in a visible and disabled state, while the processing layer may be set in a visible and enabled state. The object to be processed is operated by using an information input member, e.g., see the description below, and the operated object to be processed is overlap-displayed on the background layer. For example, the processing layer and the background layer may be overlap-displayed on a display screen of the mobile terminal, and the states of the processing layer and the background layer can be set.

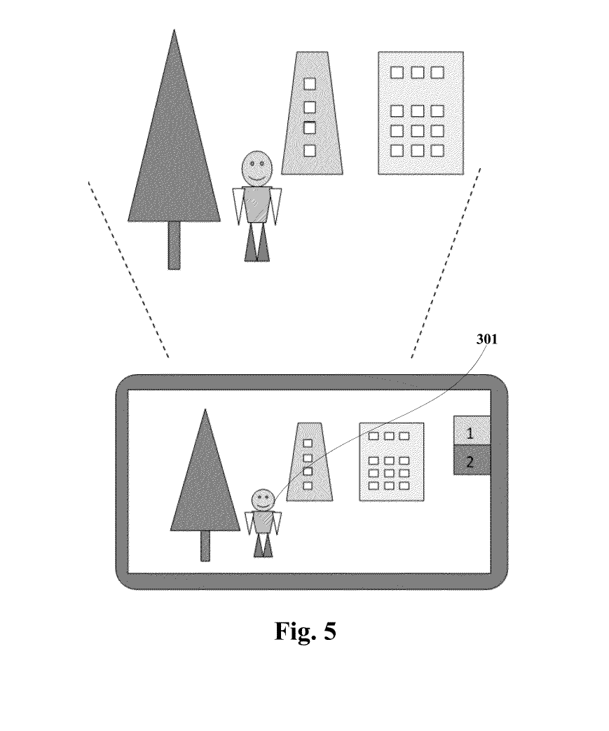

FIG. 5 is an example diagram of overlap-displaying the background layer and the processing layer according to an embodiment of the present disclosure. As illustrated in FIG. 5, the background layer and the processing layer may be both displayed on a screen. For example, when a display begins, the background layer and the processing layer may be both set in visible and disabled state (for example, disabled means that the image or layer is locked so that the image or layer cannot be adjusted).

In this embodiment, when the object to be processed is to be operated (for example, adjusted by touching a touch screen with one or more fingers), the background layer may be set in the visible and disabled state, and the processing layer may be set in the visible and enabled state (for example, enabled means that the image or layer is able to be adjusted). Next, the object to be processed is operated (or adjusted) by using an information input member.

Processing the object to be processed may include one or combinations of the operations of changing a position of the object to be processed, such as making a translation through dragging; changing a size of the object to be processed, such as zooming in or zooming out; changing a state of the object to be processed, such as making a rotation; and changing a display attribute of the object to be processed, such as changing color and brightness of the object to be processed. But the present disclosure is not limited thereto, and other operations may be possible.

In addition, the information input member, for example, may be a touch screen, which receives input information from the user finger to perform various operations on the object to be processed. But the present disclosure is not limited thereto, and for example the information may be input through a mouse or keypad.

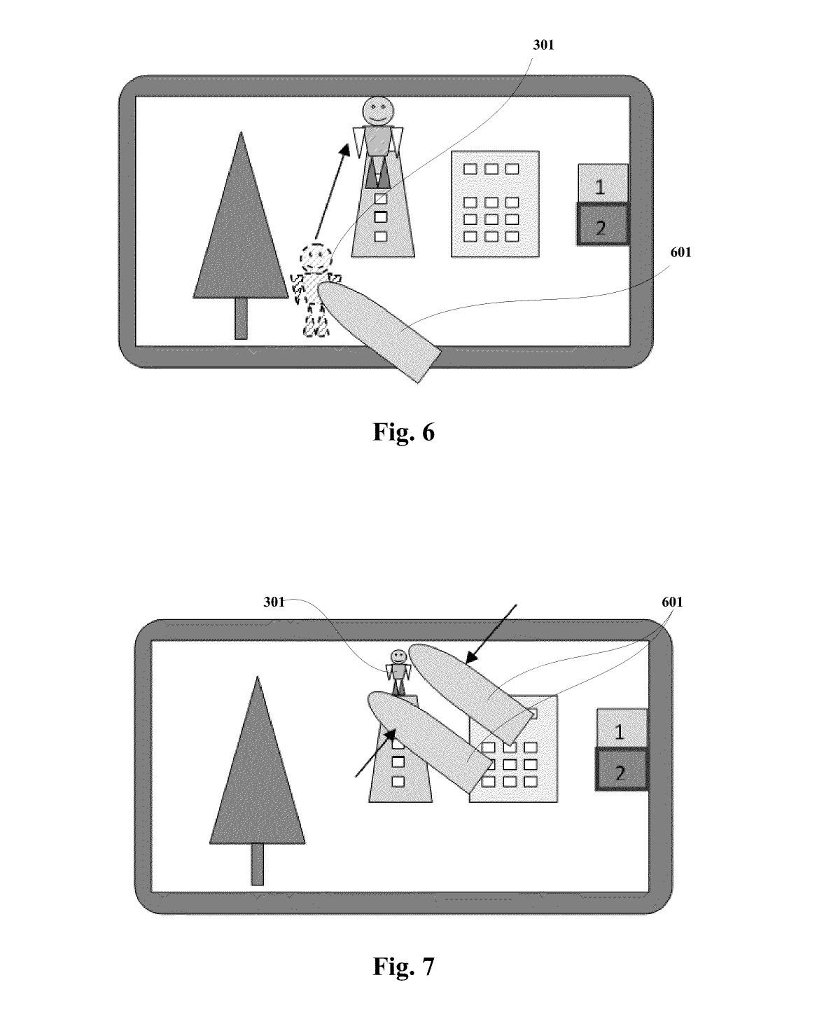

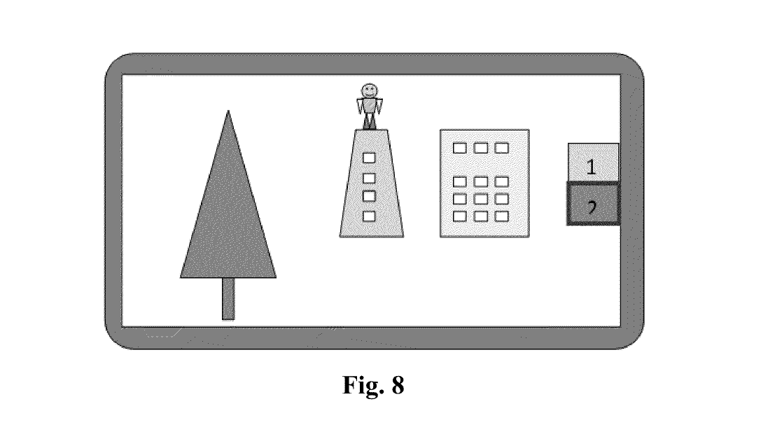

FIG. 6 is a schematic diagram of performing an operation on an object to be processed according to an embodiment of the present disclosure, which illustrates a situation of dragging an object to be processed 301 through a user's finger 601. FIG. 7 is another schematic diagram of performing an operation on an object to be processed according to an embodiment of the present disclosure, which illustrates a situation of zooming out an object to be processed 301 through a user's fingers 601. FIG. 8 is a schematic diagram when an operation is completed according to an embodiment of the present disclosure.

As illustrated in FIG. 8, being different from the image (portrait) of the object under a big tree in the actual scene, the image of the object in the embodiment of the present disclosure is moved to a building roof, and the image is zoomed out to suit the building size. Thus, the personalized image can be obtained in real time during the shooting.

In this embodiment, FIGS. 6-7 illustrate the situation of processing the object to be processed using an information input member (e.g., touch screen), but the present disclosure is not limited thereto. Processing the object to be processed to obtain the processed processing layer may further include: processing the object to be processed based on pre-stored history information, so that the object to be processed is overlap-displayed on the background layer after the processing.

For example, when brightness of the acquired image is larger than a certain threshold, it means that the image is probably shot on a sunny day, while the object (e.g. face) may be in an underexposed state due to backlighting. In that case, the brightness of the object to be processed may be automatically increased according to the history information.

To be noted, the above content only schematically describes the processing based on the history information, but the present disclosure is not limited thereto, and the specific implementation may be determined according to the actual requirement.

Step 205 (illustrated in FIG. 2): merging at least two layers to acquire an image;

wherein, the processed processing layer and background layer may be merged. Please refer to the relevant art for the specific implementation of the layer merging.

The image generation method of the present disclosure is described above through an example using two layers. But the present disclosure is not limited thereto. For example, three or more layers may also be used. In addition, the above implementation only processes the processing layer, while the background layer can also be processed. Next, the processed processing layer and/or the processed background layer are merged.

In the actual scene, although the image of the object may be adjusted as the object to be processed and then merged with the background layer, the image obtained from the merging still may not satisfy the user if the state of the object itself is unsatisfactory (e.g., the posture is improper or the face is not expressive enough).

In this embodiment, the object to be processed may be updated during the image generation, until an update result satisfactory to the user is obtained, thereby obtaining an image satisfactory to the user in real time.

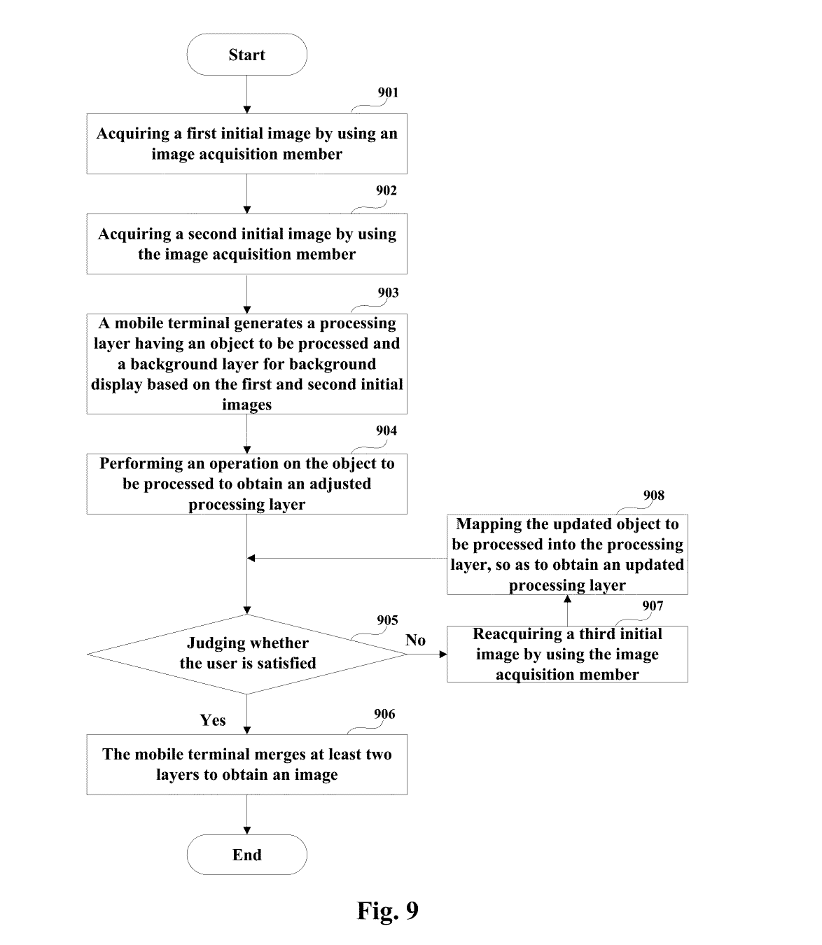

FIG. 9 is another flow diagram of an image generation method according to an embodiment of the present disclosure, which further describes the present disclosure on the basis of FIG. 2. As illustrated in FIG. 9, the image generation method includes:

Step 901: acquiring a first initial image by using an image acquisition member;

Step 902: acquiring a second initial image by using the image acquisition member;

Step 903: a mobile terminal generates a processing layer having an object to be processed and a background layer for background display based on the first and second initial images;

Step 904: performing an operation on the object to be processed to obtain an adjusted processing layer;

Step 905: judging whether the user is satisfied, and if yes, performing step 906, otherwise performing step 907.

In this embodiment, the information of whether the user is satisfied can be obtained, for example, through a man-machine interaction interface.

Step 906: the mobile terminal merges at least two layers to obtain an image;

Step 907: reacquiring a third initial image by using the image acquisition member, and generating an updated object to be processed;

wherein, the third initial image may include the updated object to be processed, such as the image of the object with the posture or facial expression changed. In addition, as described in step 203 or 903, the updated object to be processed may be similarly generated from the first and third initial images.

Step 908: mapping the updated object to be processed into the processing layer, so as to obtain an updated processing layer.

In this embodiment, a mapping relationship may be established between the object to be processed obtained in step 903 and the updated object to be processed obtained in step 907. The operation in step 904 may be automatically applied on the updated object to be processed, thereby obtaining the updated processing layer. To be noted, steps 907 and 908 may be performed for one or more times, and the object to be processed may be continuously updated until the user is satisfied.

In addition, after step 908 is performed, step 904 may be performed again to operate the object to be processed once more, thus not only the object to be processed is updated, but also the position or state of the object to be processed is adjusted again.

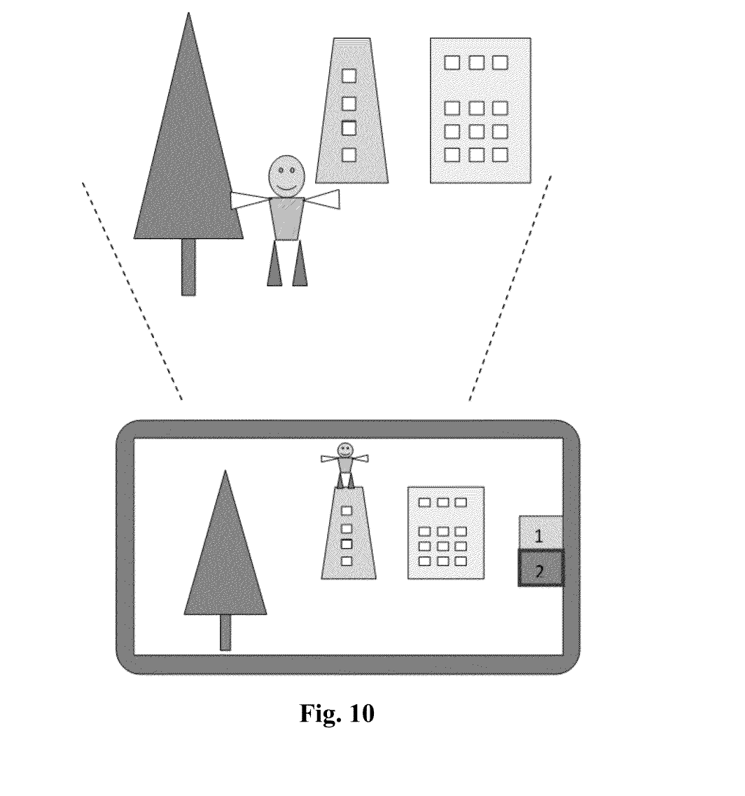

FIG. 10 is an example diagram of an updated processing layer according to an embodiment of the present disclosure. As illustrated in FIG. 10, after the third initial image is obtained by using the image acquisition member, the object with its posture or facial expression changed may be directly mapped into the processing layer, thereby dynamically updating the object to be processed, and acquiring an image satisfactory to the user in time.

The reacquisition of the initial image by using the image acquisition member is described as above, but the present disclosure is not limited thereto. For example, the initial image may also be reacquired by selecting from the pre-stored images. For example, an image with a satisfactory facial expression may be obtained from the photos previously stored in the mobile terminal, and used as the third initial image to generate the updated object to be processed.

Or, the initial image may be reacquired by being received through a network interface. For example, an image in other mobile terminal may be obtained through a WiFi interface, and used as the third initial image to generate the updated object to be processed.

Thus, by updating the object to be processed in real time during the image generation, the object and the background desired by the user can be combined together, and the object to be processed can be updated in time. As a result, the personalized image shooting can be carried out in real time to obtain better user experiences.

In this embodiment, two initial images may be shot in real time by using the image acquisition member, so as to obtain the object to be processed through a comparison, as described above. In addition, the object to be processed may also be obtained through image recognition, without making a comparison between the two images.

In this embodiment, generating at least two layers including a processing layer having an object to be processed and a background layer for background display based on the initial images may further include: generating the background layer based on the initial image; and performing image recognition of the initial image based on pre-stored image information, so as to acquire the object to be processed corresponding to the pre-stored image information.

In this embodiment the image information of the object to be processed may be pre-stored. During the actual shooting, image recognition of the initial images may be performed based on the pre-stored image information, for example, the portraits in the initial image may be recognized through a face recognition technology.

In addition, the background layer may be generated based on the initial image. For example, a portion containing the portrait is cut out of the initial image, and the image after cutting is taken as the background layer; the blank remaining in the image after cutting may be removed, or filled with a background color; and the recognized portrait is taken as the object to be processed, thus the object to be processed corresponding to the pre-stored image information is acquired.

As can be seen from the above embodiment, at least two layers including a processing layer and a background layer are generated based on the initial image; the processing layer and/or the background layer are processed; and the at least two layers including the processed processing layer and/or the processed background layer are merged to obtain an image. Thus, the personalized image shooting can be carried out in real time to obtain better user experiences.

### Embodiment 2

The embodiment of the present disclosure provides an image generation apparatus configured in a mobile terminal. The embodiment of the present disclosure is corresponding to the image generation method of Embodiment 1, and the same contents are omitted herein.

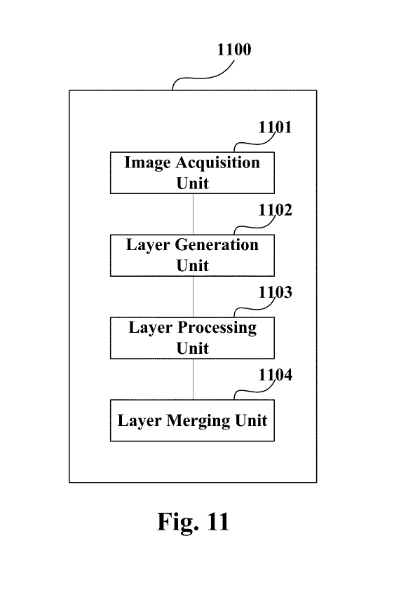

FIG. 11 is a structural diagram of an image generation apparatus according to an embodiment of the present disclosure. As illustrated in FIG. 11, an image generation apparatus 1100 includes: an image acquisition unit 1101, a layer generation unit 1102, a layer processing unit 1103 and a layer merging unit 1104.

In the apparatus 1100 the image acquisition unit 1101 is configured to acquire an initial image by using an image acquisition member. The layer generation unit 1102 is configured to generate at least two layers including a processing layer having an object to be processed and a background layer for background display, based on the initial image. The layer processing unit 1103 is configured to process the object to be processed to obtain a processed processing layer, and/or processes the background layer to obtain a processed background layer. And, the layer merging unit 1104 is configured to merge s the at least two layers including the processed processing layer and/or the processed background layer to obtain an image.

In one implementation, the image acquisition unit 1101 may be configured to acquire at least two initial images. The layer generation unit 1102 may be configured to take an image not containing the object to be processed among the at least two initial images as the background layer; and to compare an image containing the object to be processed among the at least two initial images with the background layer, and obtain the object to be processed according to a result of the comparison.

In another implementation, the layer generation unit 1102 specifically may be configured to generate the background layer based on the initial image; and perform image recognition of the initial image based on pre-stored image information, so as to acquire the object to be processed corresponding to the pre-stored image information.

In one implementation, the layer processing unit 1103 may include: a state setting unit and an object processing unit (not illustrated in the drawings). The state setting unit is configured to set the background layer in a visible and disabled state, and sets the processing layer in a visible and enabled state. The object processing unit is configured to operate (or adjust) the object to be processed by using the information input member, so that the operated object to be processed is overlap-displayed on the background layer.

In another implementation, the layer processing unit 1103 specifically may be configured to process the object to be processed based on pre-stored history information, so that the processed object to be processed is overlap-displayed on the background layer.

In this embodiment, processing the object to be processed may include one or combinations of the operations of changing a position of the object to be processed, changing a size of the object to be processed, changing a state of the object to be processed, and changing a display attribute of the object to be processed.

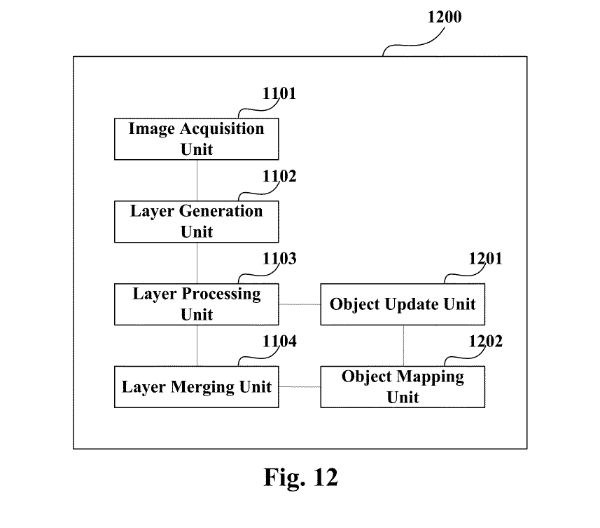

FIG. 12 is another structural diagram of an image generation apparatus according to an embodiment of the present disclosure. As illustrated in FIG. 12, an image generation apparatus 1200 includes an image acquisition unit 1101, a layer generation unit 1102, a layer processing unit 1103 and a layer merging unit 1104, as described as above.

As illustrated in FIG. 12, the image generation apparatus 1200 may further include: an object update unit 1201 and an object mapping unit 1202. The object update unit 1201 is configured to reacquire an initial image and generate an updated object to be processed. The object mapping unit 1202 is configured to map the updated object to be processed into the processing layer, so as to obtain an updated processing layer; and the layer merging unit 1104 is further configured to merge at least two layers including the updated processing layer to acquire an image.

In this embodiment, the initial image may be reacquired by using the image acquisition member, or by being selected from pre-stored images, or by being received through a network interface.

As can be seen from the above embodiment, at least two layers including a processing layer and a background layer are generated based on the initial images; the processing layer and/or the background layer are processed; and the at least two layers including the processed processing layer and/or the processed background layer are merged to obtain an image. Thus, the personalized image shooting can be carried out in real time to obtain better user experiences.

### Embodiment 3

Embodiment 3 of the present disclosure provides a mobile terminal. In this embodiment, the terminal may include the image generation apparatus of Embodiment 2, the contents thereof are incorporated herein, and the same contents are not repeated. The mobile terminal may be a cellular phone, a photo camera, a video camera, a tablet PC or a wearable device, etc., but the present disclosure is not limited thereto.

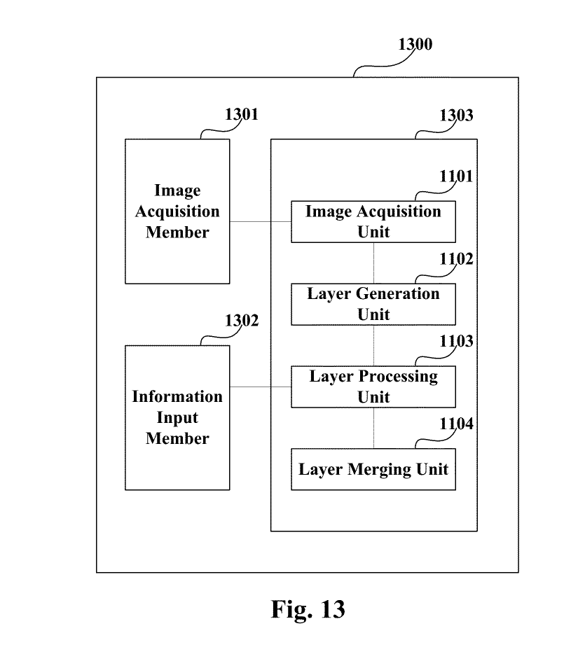

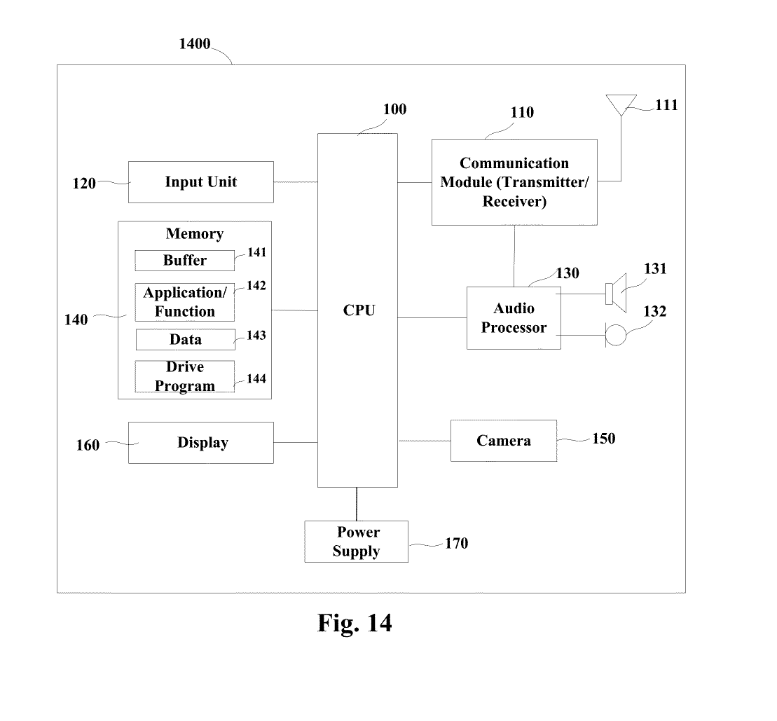

FIG. 13 is a structural diagram of a mobile terminal according to an embodiment of the present disclosure, which illustrates an example of a mobile terminal 1300. In order for simplicity, FIG. 13 only illustrates the members related to the embodiment of the present disclosure. Please refer to the relevant art for other members of the mobile terminal 1300.

As illustrated in FIG. 13, the mobile terminal 1300 includes an image acquisition member 1301, an information input member 1302 and a controller 1303, wherein the function of the image generation apparatus 1100 of Embodiment 2 may be configured in the controller 1303.

Next, a mobile communication terminal is taken as an example to further describe the mobile terminal of the present disclosure.

FIG. 14 is a block diagram of a system construction of a mobile terminal according to an embodiment of the present disclosure. The mobile terminal 1400 may include a Central Processing Unit (CPU) 100 and a memory 140 coupled to the CPU 100. To be noted, the diagram is exemplary, and other type of structure may also be used to supplement or replace the structure, so as to realize the telecom function or other function.

As illustrated in FIG. 14, the mobile terminal 1400 may further include a camera 150 (image acquisition member) and an input unit 120 (information input member).

In one implementation, the function of the image generation apparatus 1100 or 1200 may be integrated into the CPU 100, wherein the CPU 100 may be configured to perform the image generation method as described in Embodiment 1.

In another implementation, the image generation apparatus 1100 or 1200 may be configured separately from the CPU 100. For example, the image generation apparatus 1100 or 1200 may be configured as a chip connected to the CPU 100, thereby realizing the function of the image generation apparatus under the control of the CPU 100.

As illustrated in FIG. 14, the mobile terminal 1400 may further include a communication module 110, an audio processor 130, a display 160 and a power supply 170. To be noted, the mobile terminal 1400 does not necessarily include all the members illustrated in FIG. 14. In addition, the mobile terminal 1400 may also include other members not illustrated in FIG. 14, please refer to the relevant art for the details.

As illustrated in FIG. 14, the CPU 100 sometimes is called as controller or operation control, including microprocessor or other processor device and/or logic device. The CPU 100 receives an input and controls the operations of respective members of the mobile terminal 1400.

The memory 140 for example may be one or more of a buffer, a flash memory, a hard disk drive, a removable medium, a volatile memory, a nonvolatile memory or other appropriate device. The memory may store information related to the processing or adjustment, and a program for performing related information. In addition, the CPU 100 may execute the program stored in the memory 140 to realize the information storage or processing.

The input unit 120 provides an input to the CPU 100. The input unit 120 for example is a key or a touch input device. The camera 150 captures image data and supplies the captured image data to the CPU 100 for a conventional usage, such as storage, transmission, etc. The power supply 170 supplies electric power to the mobile terminal 1400. The display 160 displays objects such as images and texts. The display may be, but not limited to, an LCD.

The memory 140 may be a solid state memory, such as Read Only Memory (ROM), Random Access Memory (RAM), SIM card, etc., or a memory which stores information even if the power is off, which can be selectively erased and provided with more data, and the example of such a memory is sometimes called as EPROM, etc. The memory 140 also may be a certain device of other type. The memory 140 includes a buffer memory 141 (sometimes called a buffer). The memory 140 may include an application/function storage section 142 which stores application programs and function programs or performs the operation procedure of the mobile terminal 1400 via the CPU 100.

The memory 140 may further include a data storage section 143 which stores data such as contacts, digital data, pictures, sounds and/or any other data used by the electronic device. A drive program storage section 144 of the memory 140 may include various drive programs of the electronic device for performing the communication function and/or other functions (e.g., message transfer application, address book application, etc.) of the electronic device.

The communication module 110 is a transmitter/receiver 110 which transmits and receives signals via an antenna 111. The communication module (transmitter/receiver) 110 is coupled to the CPU 100, so as to provide an input signal and receive an output signal, which may be the same as the situation of the conventional mobile communication terminal.

Based on different communication technologies, the same electronic device may be provided with a plurality of communication modules 110, such as cellular network module, Bluetooth module and/or wireless local area network (WLAN) module. The communication module (transmitter/receiver) 110 is further coupled to a speaker 131 and a microphone 132 via an audio processor 130, so as to provide an audio output via the speaker 131, and receive an audio input from the microphone 132, thereby performing the normal telecom function. The audio processor 130 may include any suitable buffer, decoder, amplifier, etc. In addition, the audio processor 130 is further coupled to the CPU 100, so as to locally record sound through the microphone 132, and play the locally stored sound through the speaker 131.

The embodiment of the present disclosure further provides a computer readable program, which when being executed in a mobile terminal, enables a computer to perform the image generation method according to Embodiment 1 in the mobile terminal.

The embodiment of the present disclosure further provides a storage medium storing a computer readable program, wherein the computer readable program enables a computer to perform the image generation method according to Embodiment 1 in a mobile terminal.

The preferred embodiments of the present disclosure are described as above with reference to the drawings. Many features and advantages of those embodiments are apparent from the detailed Specification, thus the accompanied claims intend to cover all such features and advantages of those embodiments which fall within the true spirit and scope thereof. In addition, since numerous modifications and changes are easily conceivable to a person skilled in the art, the embodiments of the present disclosure are not limited to the exact structures and operations as illustrated and described, but cover all suitable modifications and equivalents falling within the scope thereof.

It shall be understood that each part of the present disclosure may be implemented by hardware, software, firmware, or combinations thereof. In the above embodiments, multiple steps or methods may be implemented by software or firmware stored in the memory and executed by an appropriate instruction executing system. For example, if the implementation uses hardware, it may be realized by any one of the following technologies known in the art or combinations thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

Any process, method or block in the flowchart or described in other manners herein may be understood as being indicative of including one or more modules, segments or parts for realizing the codes of executable instructions of the steps in specific logic functions or processes, and that the scope of the preferred embodiments of the present disclosure include other implementations, wherein the functions may be executed in manners different from those shown or discussed (e.g., according to the related functions in a substantially simultaneous manner or in a reverse order), which shall be understood by a person skilled in the art.

The logic and/or steps shown in the flowcharts or described in other manners here may be, for example, understood as a sequencing list of executable instructions for realizing logic functions, which may be implemented in any computer readable medium, for use by an instruction executing system, apparatus or device (such as a system based on a computer, a system including a processor, or other systems capable of extracting instructions from an instruction executing system, apparatus or device and executing the instructions), or for use in combination with the instruction executing system, apparatus or device.

The above literal descriptions and drawings show various features of the present disclosure. It shall be understood that a person of ordinary skill in the art may prepare suitable computer codes to carry out each of the steps and processes described above and illustrated in the drawings. It shall also be understood that the above-described terminals, computers, servers, and networks, etc. may be any type, and the computer codes may be prepared according to the disclosure contained herein to carry out the present disclosure by using the apparatus.

Particular embodiments of the present disclosure have been disclosed herein. A person skilled in the art will readily recognize that the present disclosure is applicable in other environments. In practice, there exist many embodiments and implementations. The appended claims are by no means intended to limit the scope of the present disclosure to the above particular embodiments. Furthermore, any reference to “an apparatus configured to . . . ” is an explanation of apparatus plus function for describing elements and claims, and it is not desired that any element using no reference to “an apparatus configured to . . . ” is understood as an element of apparatus plus function, even though the wording of “apparatus” is included in that claim.

Although a particular preferred embodiment or embodiments have been shown and the present disclosure has been described, it will be appreciated by those having ordinary skill in the art that equivalent modifications and variants are conceivable to a person skilled in the art in reading and understanding the description and drawings. Especially for various functions executed by the above elements (parts, components, apparatus, and compositions, etc.), except otherwise specified, it is desirable that the terms (including the reference to “apparatus”) describing these elements correspond to any element executing particular functions of these elements (i.e. functional equivalents), even though the element is different from that executing the function of an exemplary embodiment or embodiments illustrated in the present disclosure with respect to structure. Furthermore, although the a particular feature of the present disclosure is described with respect to only one or more of the illustrated embodiments, such a feature may be combined with one or more other features of other embodiments as desired and in consideration of advantageous aspects of any given or particular application.

1. An image generation method, comprising:
acquiring an initial image by using an image acquisition member;
generating at least two layers comprising a processing layer having an object to be processed and a background layer for background display, based on the initial image;
processing the object to be processed to obtain a processed processing layer, and/or processing the background layer to obtain a processed background layer; and
merging the at least two layers comprising the processed processing layer and/or the processed background layer to obtain an image.

2. The image generation method according to claim 1, wherein generating at least two layers comprising a processing layer having an object to be processed and a background layer for background display based on the initial image, comprises:
acquiring at least two initial images;
taking an image not containing the object to be processed among the at least two initial images as the background layer;
comparing an image containing the object to be processed among the at least two initial images with the background layer, and obtaining the object to be processed according to a result of the comparison.

3. The image generation method according to claim 1, wherein generating at least two layers comprising a processing layer having an object to be processed and a background layer for background display based on the initial image, comprises:
generating the background layer based on the initial image; and
performing image recognition of the initial image based on pre-stored image information, so as to acquire the object to be processed corresponding to the pre-stored image information.

4. The image generation method according to claim 1, wherein processing the object to be processed to obtain a processed processing layer comprises:
setting the background layer in a visible and disabled state, and setting the processing layer in a visible and enabled state;
processing the object to be processed by using an information input member, so that the object to be processed is overlap-displayed on the background layer after the processing.

5. The image generation method according to claim 1, wherein processing the object to be processed to obtain a processed processing layer comprises:
processing the object to be processed based on pre-stored history information, so that the object to be processed is overlap-displayed on the background layer after the processing.

6. The image generation method according to claim 4, wherein processing the object to be processed comprises one or combinations of the operations of changing a position of the object to be processed, changing a size of the object to be processed, changing a state of the object to be processed, and changing a display attribute of the object to be processed.

7. The image generation method according to claim 1, wherein after processing the object to be processed to obtain a processed processing layer, the image generation method further comprises:
reacquiring an initial image, and generating an updated object to be processed;
mapping the updated object to be processed into the processing layer, so as to obtain an updated processing layer.

8. The image generation method according to claim 7, wherein the initial image is reacquired by using an image acquisition member, or by being selected from pre-stored images, or by being received through a network interface.

9. An image generation apparatus, comprising:
an image acquisition unit, configured to acquire an initial image by using an image acquisition member;
a layer generation unit, configured to generate at least two layers comprising a processing layer having an object to be processed and a background layer for background display, based on the initial image;
a layer processing unit, configured to process the object to be processed to obtain a processed processing layer, and/or process the background layer to obtain a processed background layer; and
a layer merging unit, configured to merge the at least two layers comprising the processed processing layer and/or the processed background layer to obtain an image.

10. The image generation apparatus according to claim 9, wherein the image acquisition member acquires at least two initial images;
the layer generation unit is specifically configured to take an image not containing the object to be processed among the at least two initial images as the background layer; and compare an image containing the object to be processed among the at least two initial images with the background layer, and obtain the object to be processed according to a result of the comparison.

11. The image generation apparatus according to claim 9, wherein the layer generation unit is specifically configured to generate the background layer based on the initial image; and perform image recognition of the initial image based on pre-stored image information, so as to acquire the object to be processed corresponding to the pre-stored image information.

12. The image generation apparatus according to claim 9, wherein the layer processing unit comprises:
a state setting unit, configured to set the background layer in a visible and disabled state, and set the processing layer in a visible and enabled state;
an object processing unit, configured to process the object to be processed by using an information input member, so that the object to be processed is overlap-displayed on the background layer after the processing.

13. The image generation apparatus according to claim 9, wherein the layer processing unit is specifically configured to process the object to be processed based on pre-stored history information, so that the object to be processed is overlap-displayed on the background layer after the processing.

14. The image generation apparatus according to claim 12, wherein processing the object to be processed comprises one or combinations of the operations of changing a position of the object to be processed, changing a size of the object to be processed, changing a state of the object to be processed, and changing a display attribute of the object to be processed.

15. The image generation apparatus according to claim 9, further comprising:
an object update unit, configured to reacquire an initial image and generate an updated object to be processed; and
an object mapping unit, configured to map the updated object to be processed into the processing layer, so as to obtain an updated processing layer.

16. The image generation apparatus according to claim 15,
wherein the initial image is reacquired by using an image acquisition member, or by being selected from pre-stored images, or by being received through a network interface.

17. A mobile terminal, comprising the image generation apparatus according to claim 9.
